(19) United States
(12) Patent Application Publication
(10) Pub. No.: US 2025/0230706 A1
(43) Pub. Date: Jul. 17, 2025

(54) Restroom Privacy Barrier

(71) Applicant: Jesus Sanchez, Houston, TX (US)

(72) Inventor: Jesus Sanchez, Houston, TX (US)

(21) Appl. No.: 18/802,953

(22) Filed: Aug. 13, 2024

Related U.S. Application Data
(63) Continuation-in-part of application No. 18/415,406, filed on Jan. 17, 2024.

(51) Int. Cl. E06B 7/28

(52) U.S. Cl. CPC E06B 7/28

(57) ABSTRACT

A restroom privacy barrier is disclosed allowing for users of restroom stalls to cover gaps that may appear between the walls, panels, or doors commonly found in public restrooms. The restroom privacy barrier includes adhesive zones wherein the barrier may be temporarily adhered to a surface, such as a restroom stall door or wall panel thus covering the gap and preventing prying eyes from viewing the occupant of the restroom stall. The barrier may include a spine for additional resilience and rigidity and also provide additional strength or adhesive contact points for adherence to surfaces. The restroom privacy barrier can have other applications such as using the adhesive to temporarily seal the restroom stall door when the latch or lock is non-functional or even when it is functional.

### PRIORITY CLAIM

This application is a continuation-in-part and claims priority to pending U.S. application Ser. No. 18/415,406, filed Jan. 17, 2024

### BACKGROUND OF THE INVENTION

Many public restrooms have stalls and walls that may contain gaps between the wall panels and/or doors, whether purposely designed in that manner or developed over time from wear and tear of the stall fixtures, fasteners, and connections. Sometimes these gaps are sufficiently wide to cause the door latches to not properly latch as intended, thus allowing the door to swing freely and not allowing for privacy for the occupant of the restroom stall. This can also be a security issue in some instances where a door fails to latch or lock properly. However, this is just one advantage of the restroom privacy barrier, even when the latch or lock is in working condition, the occupant may still desire additional privacy, such occupants may include men, women, children, elderly persons, teenagers, and other vulnerable classes of person, as discussed in more detail below.

Otherwise, the gaps may be wide enough that the occupant of the restroom stall may perceive that other persons in the restroom are able to see through the gap(s) and depriving the occupant of privacy. Sometimes, the occupant may suffer from paruresis (shy bladder syndrome), parcopresis (shy bowel syndrome), or other social anxiety disorder or phobia, such as scopophobia (fear of being watched). Whether the occupant is actually be observed by other restroom users or not, these feelings and perceptions are real to the occupant and can be debilitating when the occupant needs to evacuate bodily waste in the restroom and can often result in frustration or more serious medical complications from not evacuating in a timely manner. This is countered by some understanding of the history that such gaps may be purposefully designed into restroom stall installations to aid with cleaning of the restrooms. The use of the instant invention being readily removable can provide temporary privacy without removing purposeful gaps in such restroom stalls. As mentioned above, the use of the instant invention can help alleviate stress, anxiety, and tension of the occupant of the restroom stall, where purposeful or inadvertent gaps may induce anxiety of being seen thus causing occupants to take longer to evacuate waste and thus occupy the facilities longer they may desire. This outcome can defeat an intended purpose of introducing such gaps to the stalls in an attempt to force persons to evacuate quickly, thus freeing the stall for the next person. Such anxiety can even cause the occupant to fail to evacuate, thus defeating the purpose of the restroom facilities and potentially cause more distress to the unsuccessful occupants. The disclosed invention can help persons evacuate more expediently by providing necessary temporary privacy, thus achieving the goals of providing privacy while balancing it with cleaning procedures and not requiring a redesign or installation of new walls.

Another aspect of the invention relates to aiding persons that may need mobility aids, such as canes, crutches, wheelchairs, mobility scooters, or other assistance when using a restroom, such persons may require various states of undress to complete their activities in a restroom stall, thus desiring additional privacy, such as those provided by the instant invention. Similarly, such activities may include changing diapers, pads, ostomy bags (colostomy and ileostomy), urinary catheter tubing or drainage bags, among other known conditions and mechanisms. It can be desirable for such persons to achieve additional privacy in restrooms during such procedures.

Another security related aspect to the gaps occurring in restroom stall walls is that for transgender persons that may not feel comfortable or safe in the gendered restroom they are forced to use. Gaps between the wall panels or doors of the restroom stall may provide transphobic persons the ability to spy or harass the occupant of the stall. As such, restroom privacy may be a critical safety issue for some people.

While some modern restroom stall designs include rabbeted panel edges to eliminate or reduce gaps while still allowing for room to operate the swinging door, such designs and renovations can be prohibitively expensive for many businesses to install when compared to conventional restroom stall panel designs. As such, there is a need and unmet demand for a restroom privacy barrier as disclosed and claimed herein.

### SUMMARY OF THE INVENTION

The inventor has created a revolutionary and novel restroom privacy barrier with the goal to improve privacy within a restroom setting, such as blocking other restroom users from viewing a person using a restroom stall or covering gaps or cracks between restroom stall walls and/or doors. The restroom privacy barrier claimed herein is preferably single use, but some embodiments may allow for multiple re-uses before disposal. It is also preferable to use pre-sanitized material in the construction of the restroom privacy barrier. Other applications of the present invention can solve the issue of broken or non-functional latching or locking devices commonly found in restroom stalls by allowing the user and occupant of the stall to use the privacy barrier to adhere to one or more points on the restroom stall door, wall, or panels to maintain a level of privacy and preventing the door from swinging open. However, this is just one advantage of the restroom privacy barrier, even when the latch or lock is in working condition, the occupant may still desire additional privacy. Yet other applications of the present invention can include use as a barrier within a walled shower stall with a door to prevent water from escaping between gaps of the shower walls and/or door. It should be appreciated that some embodiments comprise biodegradable and/or flushable material compositions while other embodiments may comprise water-resistant or water-proof material(s) intended for discarding in the trash after use. It should be appreciated that some embodiments may comprise material compositions that allow for multiple re-uses before discarding the barrier.

The present invention may include embodiments that comprise a first layer of material comprising a length, a proximal end, a distal end, a top surface, and a bottom surface; a spine, said spine comprising a length greater than the length of said first layer of material, a proximal end, a distal end, a top surface, and a bottom surface; a plurality of adhesive zones wherein an adhesive material is disposed; wherein said bottom surface of said spine is disposed on said top surface of said first layer of material, wherein said proximal end of said spine extends beyond the proximal end of said first layer of material forming a first tab and said distal end of said spine extends beyond the distal end of said first layer of material forming a second tab. Other embodiments of the present invention may comprise a second layer of material comprising a length, a proximal end, a distal end, a top surface, and a bottom surface, wherein said bottom surface of said second layer of material is disposed on said top surface of said first layer of material and said top surface of said spine, wherein said top surface of first layer of material is fixedly joined to said bottom surface of said second layer of material, wherein said spine movably extends through the fixedly joined first layer of material and second layer of material. Still other embodiments of the present invention may comprise a plurality of adhesive zones which are disposed on the bottom surfaces of said proximal and distal ends of said spine. Still other embodiments of the present invention may comprise a plurality of adhesive zones disposed on the bottom surface of said first layer of material at said proximal and distal ends of said first layer of material. Still other embodiments of the present invention may comprise a restroom privacy barrier comprising a plurality of wings extended at a medial point of said length of material of said first layer of material or said second layer of material or both, wherein said plurality of wings each comprise a bottom surface and top surface, whereupon disposed on each of said bottom surface of said plurality of wings is a wing adhesive zone. Still other embodiments of the present invention may comprise a restroom privacy barrier having a second layer of material further comprising a medial point, wherein a through hole is formed in said second layer of material, wherein a loop is formed of a length of material forming said spine, wherein said loop extends through the through hole formed at the medial point of said second layer of material. Still other embodiments of the present invention may comprise a restroom privacy barrier wherein said first layer material, said second layer of material, and said spine comprise a biodegradable, flushable, and/or water-soluble composition.

### BRIEF DESCRIPTION OF DRAWINGS

FIG. 1 is an isometric view of a typical restroom stall with an embodiment installed.

FIG. 2 is a top view of an embodiment of the restroom privacy barrier.

FIG. 3 is a bottom view of an embodiment of the restroom privacy barrier.

FIG. 4 is an alternative top view of an embodiment of the restroom privacy barrier.

FIG. 5 is an exploded, isometric view of an embodiment of the restroom privacy barrier.

FIG. 6 is a top view of an alternative embodiment of the restroom privacy barrier.

FIG. 7 is a bottom view of an alternative embodiment of the restroom privacy barrier.

FIG. 8 is a top view of an alternative embodiment of the restroom privacy barrier.

FIG. 9 is an isometric view of an alternative embodiment of the restroom privacy barrier.

FIG. 10 is a top view of an alternative embodiment of the restroom privacy barrier.

FIG. 11 is a top view of an alternative embodiment of the restroom privacy barrier.

FIG. 12 is a top view of an alternative embodiment of the restroom privacy barrier.

FIG. 13 is a top view of an alternative embodiment of the restroom privacy barrier.

FIG. 14 is a top view of an alternative embodiment of the restroom privacy barrier.

FIG. 15 is a top view of an alternative embodiment of the restroom privacy barrier.

### DETAILED DESCRIPTION

One or more illustrative embodiments incorporating the invention disclosed herein are presented below.

In the following description, certain details are set forth such as specific quantities, sizes, etc. to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing embodiments of the disclosure and are not intended to be limiting thereto. Drawings are not necessarily to scale and arrangements of specific units in the drawings can vary.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless, or essentially meaningless, the definition should be taken from Webster's Dictionary, 2023. Definitions and/or interpretations should not be incorporated from other patent applications, patents, or publications, related or not, unless specifically stated in this specification, or if the incorporation is necessary for maintaining validity.

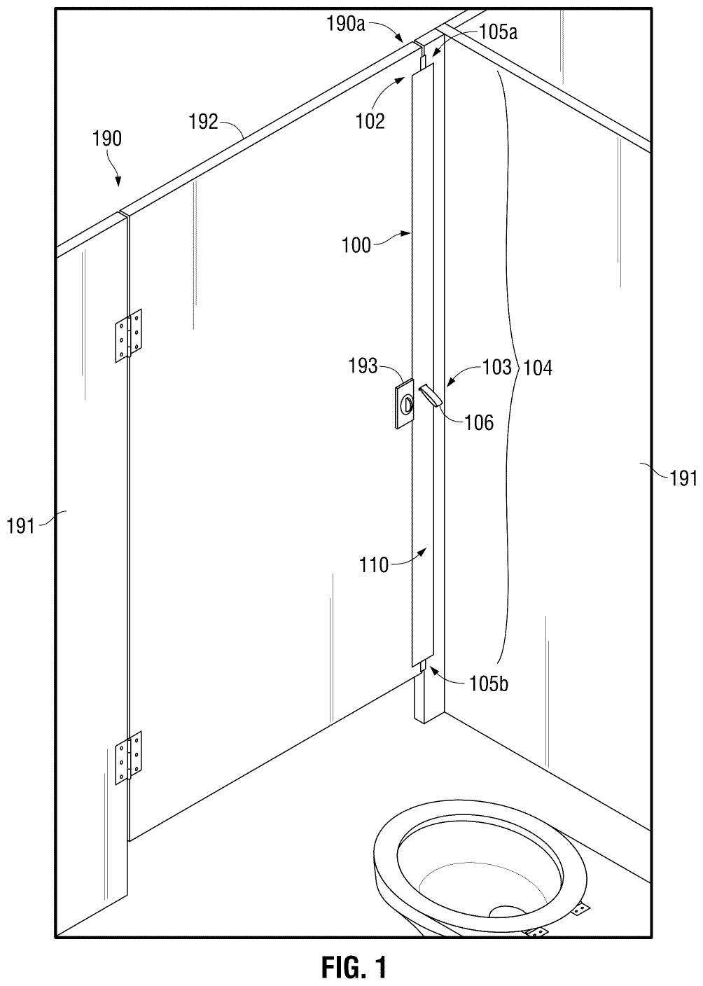

FIG. 1 depicts an embodiment of the present invention, the restroom privacy barrier 100, in an intended use within a walled restroom stall 190. The restroom stall may include one or more wall panels 191, a door 192, and a latch or lock 193. As will be known to users of restroom stalls the wall panels and/or door may include one or more gaps 190a between multiple wall panels 191 and/or the door 192. The restroom privacy barrier device 100 may include a length of material 104 having proximal 101 and distal 102 ends. The length of material 104 may also include a medial point 103. The length of material may be constructed of multiple layers of material. Some embodiments including multiple layers of material may be laminated, stitched, or glued together to create a singular unit of material. Some embodiments may include one or more tabs 105a and 105b extending from the proximal 101 and distal 102 ends. Other embodiments may include one or more tabs disposed on an underside surface of the length of material at the proximal and distal ends. Other embodiments may include one or more zones comprising an adhesive substance at or proximate to the proximal and distal ends of the length of material. The medial point of the length of material may also have a tab or loop 106 extending away from a topside surface 110 of the length of material. Such tab or loop 106 disposed at the medial point 103 may be used as a pull tab when the user is finished with their use of the restroom stall to disengage the adhesive substance disposed at the proximal 101 and distal 102 ends of the length of material 104. Other embodiments may incorporate the one or more tabs extending from the proximal and distal ends as pull tabs to disengage an adhesive substance disposed at the proximal and distal ends of the length of material, whether in the one or more zones comprising an adhesive substance or one or more tabs having an adhesive substance disposed thereon.

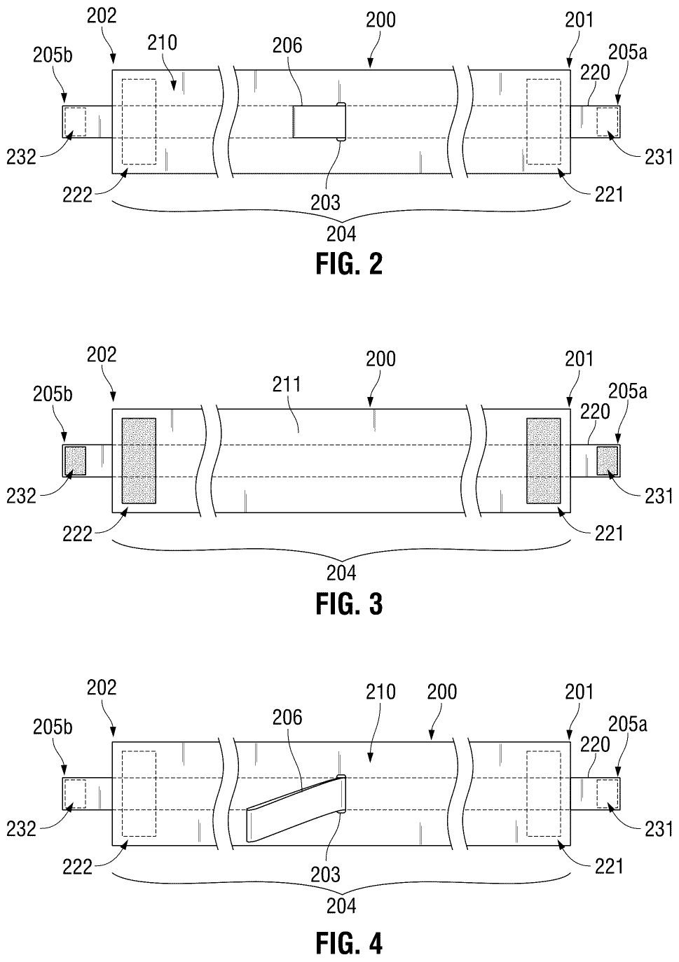

FIG. 2 depicts a topside view of an embodiment of the restroom privacy barrier 200. The length of material 204 should be appreciated that the disconnected wavey lines represent a further extension or shortening of the length of material, also shown in FIGS. 3, 4, 5, 6, 7, 8, 9, 10, 11, and 12. Based on the teachings in this description, the length of the restroom privacy barrier can vary greatly depending on the manufacturing or user's preferences and typical heights of restroom stall walls and doors. It should be appreciated that the present invention can be shortened or lengthened to several degrees while not deviating from the teaching and disclosure and spirit of the present invention. As shown in FIG. 2, some embodiments may contain a spine 220 of material running the length of the length of material 204 comprising the topside 210 and underside 211 (see FIG. 3) of the restroom privacy barrier 200. It should be appreciated that topside 210 and underside 211 may also be referred to as first layer of material and second layer of material, each having a top surface and a bottom surface, respectively. It should also be appreciated that the topside 210 and underside 211 may be fixedly attached to each through various mechanisms of attachment including, but not limited to, crimping, sewing, stitching, adhesive, folding, rolling, and other manners of adjoining two or more layers of material known in the art. Such fixed joinder may extend along the edges or seams of the lengths of material or may be disposed along the surfaces of the lengths of material. Some embodiments may include a spine 220 that extends through the multiple layers of material and juts out of the proximal 201 and distal 202 ends of the length of material 104. Some embodiments include adhesive zones 231 and 232 disposed on the underside of the spine tabs 205a and 205b extending the proximal 201 and distal 202 ends of the length of material 204. Some embodiments include adhesive zones 221 and 222 disposed on the underside 211 (see FIG. 3) of the length of material bottom layer at the proximal 201 and distal 202 ends of the length of material 204 comprising the restroom privacy barrier 200. Some embodiments include at a medial point 203 of the length of material 204 a tab or loop 206 extending away from a topside surface 210 of the length of material. Such tab or loop 206 disposed at the medial point 203 may be used as a pull tab when the user is finished with their use of the restroom stall to disengage the adhesive substance 221 and 222 disposed at the proximal 201 and distal 202 ends of the length of material and/or adhesive substance 231 and 232 disposed on the underside surface of spine tabs 205a and 205b.

FIG. 3 depicts an underside view of an embodiment of the restroom privacy barrier 200. Some embodiments may contain a spine 220 of material running the length of the length of material 204 comprising the topside 210 and underside 211 of the restroom privacy barrier 200. Some embodiments may include a spine 220 that extends through the multiple layers of material and juts out of the proximal 201 and distal 202 ends of the length of material. Some embodiments include adhesive zones 231 and 232 disposed on the underside of the spine tabs 205a and 205b extending from the proximal 201 and distal 202 ends of the length of material 204. Some embodiments include adhesive zones 221 and 222 disposed on the underside 211 of the length of material 204 bottom layer at the proximal 201 and distal 202 ends of the length of material comprising the restroom privacy barrier. Some embodiments include at a medial point 203 (see FIG. 2) of the length of material 204 a tab or loop 206 extending away from a topside 210 surface of the length of material. Such tab or loop 206 disposed at the medial point 203 may be used as a pull tab when the user is finished with their use of the restroom stall to disengage the adhesive substance 221 and 222 disposed at the proximal 201 and distal 202 ends of the length of material and/or adhesive substance 231 and 232 disposed on the underside surface of spine tabs 205a and 205b.

FIG. 4 depicts a top side view of an embodiment of the restroom privacy barrier 200. embodiments may contain a spine 220 of material running the length of the length of material 204 comprising the topside 210 and underside 211 (see FIG. 3) of the restroom privacy barrier 200. Some embodiments may include a spine 220 that extends through the multiple layers of material and juts out of the proximal 201 and distal 202 ends of the length of material 104. Some embodiments include adhesive zones 231 and 232 disposed on the underside of the spine tabs 205a and 205b extending the proximal 201 and distal 202 ends of the length of material 204. Some embodiments include adhesive zones 221 and 222 disposed on the underside 211 (see FIG. 3) of the length of material bottom layer at the proximal 201 and distal 202 ends of the length of material 204 comprising the restroom privacy barrier 200. Some embodiments include at a medial point 203 of the length of material 204 a tab or loop 206 extending away from a topside surface 210 of the length of material. Such tab or loop 206 disposed at the medial point 203 may be used as a pull tab when the user is finished with their use of the restroom stall to disengage the adhesive substance 221 and 222 disposed at the proximal 201 and distal 202 ends of the length of material and/or adhesive substance 231 and 232 disposed on the underside surface of spine tabs 205a and 205b.

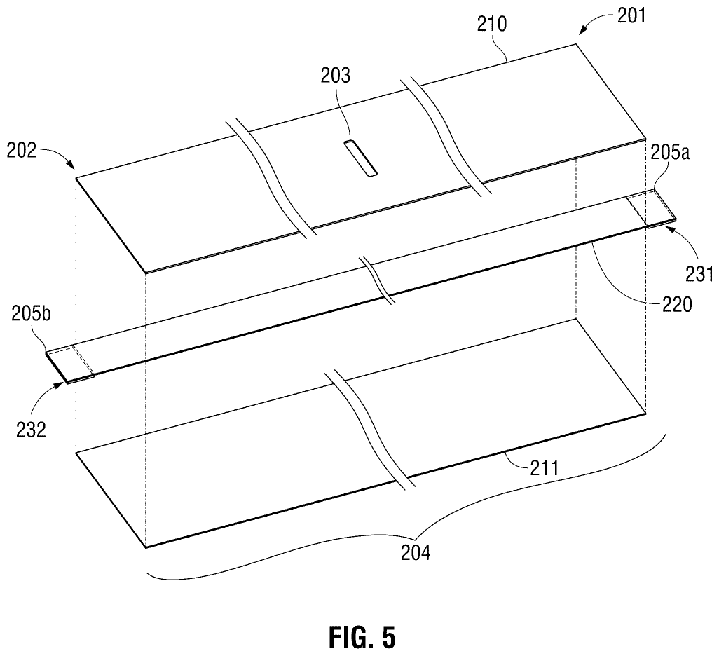

FIG. 5 depicts an exploded view of an embodiment of the restroom privacy barrier 200. Some embodiments may contain a spine 220 of material running the length of the length of material 204 comprising the topside 210 and underside 211 of the restroom privacy barrier. Some embodiments may include a spine 220 that extends through the multiple layers of material and juts out of the proximal 210 and distal 202 ends of the length of material 204. Some embodiments include adhesive zones 231 and 232 disposed on the underside of the spine tabs 205a and 205b extending the proximal 201 and distal 202 ends of the length of material 204. Some embodiments include adhesive zones 231 and 232 disposed on the underside 211 of the length of material bottom layer at the proximal 201 and distal 202 ends of the length of material 204 comprising the restroom privacy barrier 200. Some embodiments include at a medial point 203 of the length of material 204 wherein a hole is formed through the topside layer of material 210 and includes a spine 220 forming a tab or loop extending away from a topside surface of the length of material (see FIG. 4). Such tab or loop disposed at the medial point 203 may be used as a pull tab when the user is finished with their use of the restroom stall to disengage the adhesive substance 221 and 222 disposed at the proximal 201 and distal 202 ends of the length of material and/or adhesive substance 231 and 232 disposed on the underside surface of spine tabs 205a and 205b (see FIG. 2, 3, 4).

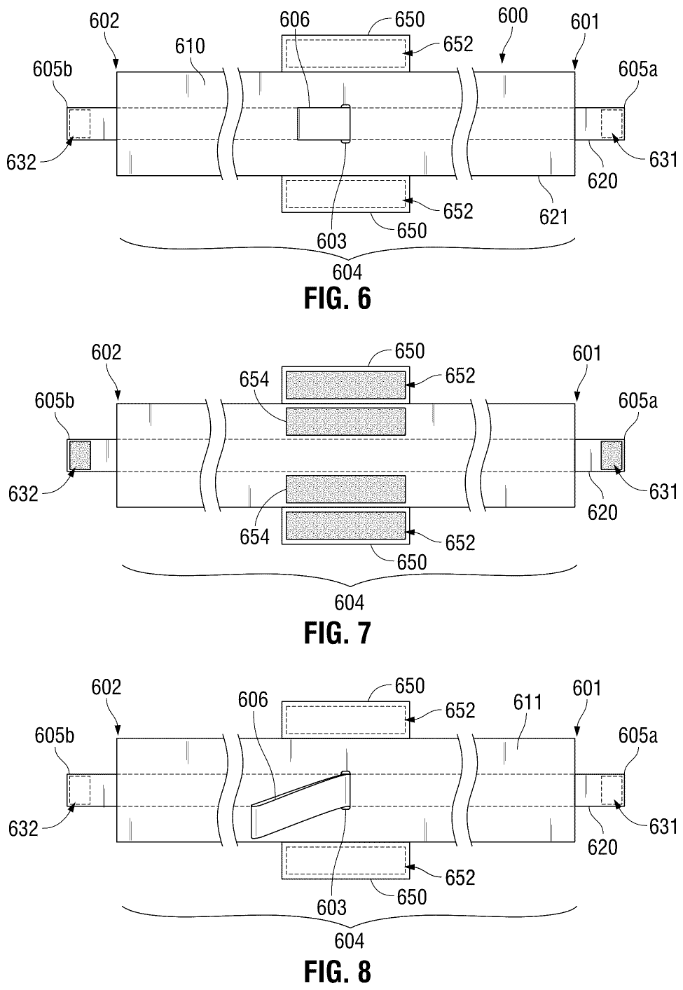

FIG. 6 depicts a topside view of an embodiment of the restroom privacy barrier 600. Some embodiments of the restroom privacy barrier may include wings 650 which may include zones for an adhesive substance 652. A benefit of some embodiments including wings 650 with adhesive substances 652 is to provide additional security or stabilization when a restroom stall latch or lock is inoperable or inadequately functions to secure the restroom stall door in a closed position. The incorporation of the wings 650 allows for the restroom privacy barrier 600 to adhere to the stall door and wall and provide additional security to prevent the door from swinging open through lack of a functional lock or latch. Some embodiments may contain a spine 620 of material running the length of the length of material 604 comprising the topside 610 and underside 611 of the restroom privacy barrier 600. Some embodiments may include a spine 620 that extends through the multiple layers of material and juts out of the proximal 601 and distal 602 ends of the length of material 604. Some embodiments include adhesive zones 631 and 632 disposed on the underside of the spine tabs 605a and 605b extending the proximal 601 and distal 602 ends of the length of material 604. Some embodiments include adhesive zones 631 and 632 disposed on the underside 611 of the length of material bottom layer at the proximal 601 and distal 602 embodiments include at a medial point 603 of the length of material 604 a tab or loop 606 extending away from a topside surface 610 of the length of material. Such tab or loop 606 disposed at the medial point 603 may be used as a pull tab when the user is finished with their use of the restroom stall to disengage the adhesive substance 631 and 632 disposed on the spine tabs 605a and 605b at the proximal 601 and distal 602 ends of the length of material 604.

FIG. 7 depicts an underside view of an embodiment of the restroom privacy barrier 600. Some embodiments of the restroom privacy barrier may include wings 650 which may include zones for an adhesive substance 652. A benefit of some embodiments including wings 650 with adhesive substances 652 is to provide additional security or stabilization when a restroom stall latch or lock is inoperable or inadequately functions to secure the restroom stall door in a closed position. The incorporation of the wings 650 allows for the restroom privacy barrier 600 to adhere to the stall door and wall and provide additional security to prevent the door from swinging open through lack of a functional lock or latch. Some embodiments may contain a spine 620 of material running the length of the length of material 604 comprising the topside 610 and underside 611 of the restroom privacy barrier 600. Some embodiments may include a spine 620 that extends through the multiple layers of material and juts out of the proximal 601 and distal 602 ends of the length of material 604. Some embodiments include adhesive zones 631 and 632 disposed on the underside of the spine tabs 605a and 605b extending the proximal 601 and distal 602 ends of the length of material 604. Some embodiments include adhesive zones 631 and 632 disposed on the underside 611 of the length of material bottom layer at the proximal 601 and distal 602 ends of the length of material 604 comprising the restroom privacy barrier 600. Some embodiments include at a medial point 603 of the length of material 604 a tab or loop 606 extending away from a topside surface 610 of the length of material. Such tab or loop 606 disposed at the medial point 603 may be used as a pull tab when the user is finished with their use of the restroom stall to disengage the adhesive substance 631 and 632 disposed on the spine tabs 605a and 605b at the proximal 601 and distal 602 ends of the length of material 604.

FIG. 8 depicts a topside view of an embodiment of the restroom privacy barrier 600. Some embodiments of the restroom privacy barrier may include wings 650 which may include zones for an adhesive substance 652. A benefit of some embodiments including wings 650 with adhesive substances 652 is to provide additional security or stabilization when a restroom stall latch or lock is inoperable or inadequately functions to secure the restroom stall door in a closed position. The incorporation of the wings 650 allows for the restroom privacy barrier 600 to adhere to the stall door and wall and provide additional security to prevent the door from swinging open through lack of a functional lock or latch. Some embodiments may contain a spine 620 of material running the length of the length of material 604 comprising the topside 610 and underside 611 of the restroom privacy barrier 600. Some embodiments may include a spine 620 that extends through the multiple layers of material and juts out of the proximal 601 and distal 602 ends of the length of material 604. Some embodiments include adhesive zones 631 and 632 disposed on the underside of the spine tabs 605a and 605b extending the proximal 601 and distal 602 ends of the length of material 604. Some embodiments include adhesive zones 631 and 632 disposed on the underside 611 of the length of material bottom layer at the proximal 601 and distal 602 embodiments include at a medial point 603 of the length of material 604 a tab or loop 606 extending away from a topside surface 610 of the length of material. Such tab or loop 606 disposed at the medial point 603 may be used as a pull tab when the user is finished with their use of the restroom stall to disengage the adhesive substance 631 and 632 disposed on the spine tabs 605a and 605b at the proximal 601 and distal 602 ends of the length of material 604.

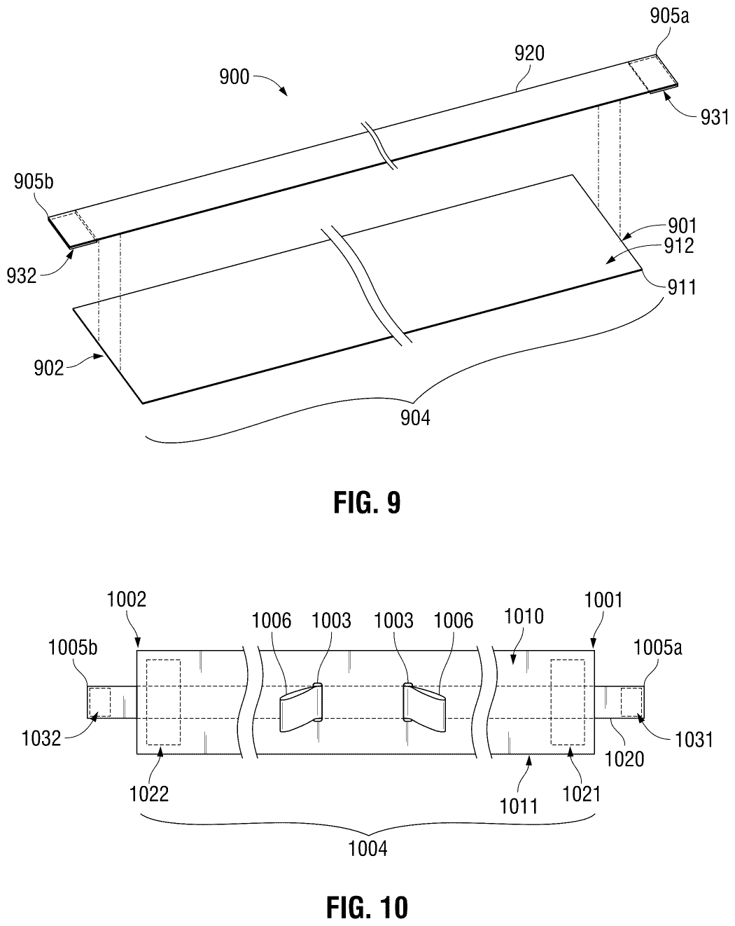

FIG. 9 depicts an isometric view of an embodiment of the restroom privacy barrier 900. Some embodiments of the restroom privacy barrier may comprise a spine 920 of material running the length of a length of material 904 comprising a topside surface 910 and an underside surface 911 of the restroom privacy barrier 900. Some embodiments may include a spine 920 that is attached to a layer of material and extends away from a proximal 910 and distal 902 end of the length of material 904. It should be appreciated that the spine 920 may be disposed on the topside 910 or the underside 911 of the restroom privacy barrier 900, while still achieving the same operation and functionality. Some embodiments may include adhesive zones 931 and 932 disposed on a surface of the spine 920 extending away from the proximal 901 and distal 902 ends of the length of material.

FIG. 10 depicts a top view of an embodiment of the restroom privacy barrier 1000. Some embodiments may contain a spine 1020 of material running the length of a length of material 1004 comprising the topside 1010 and underside 1011 of the restroom privacy barrier 1000. Some embodiments may include a spine 1020 that extends through the multiple layers of material and juts out of the proximal 1001 and distal 1002 ends of the length of material 1004. Some embodiments include adhesive zones 1031 and 1032 disposed on the underside of the spine tabs 1005a and 1005b extending the proximal 1001 and distal 1002 ends of the length of material. Some embodiments include adhesive zones 1021 and 1022 disposed on the underside 1011 of the length of material bottom layer at the proximal 1001 and distal 1002 ends of the length of material 1004 comprising the restroom privacy barrier 1000. Some embodiments include a plurality of through holes 1003 formed through the topside layer 1010 of material and include a spine 1020 forming a plurality of tabs or loops 1006 extending through the through holes 1003 and away from a topside surface 1010 of the length of material 1004. Such plurality of tabs or loops 1006 disposed between the proximal 1001 and distal 1002 ends may be used as a pull tab or leverage point when the user is finished with their use of the restroom stall to disengage the adhesive substance 1021 and 1022 disposed at the proximal 1001 and distal 1002 ends of the length of material or the adhesive substance 1031 and 1032 disposed on the surfaces of the spine tabs 1005a and 1005b extending away from the proximal 1001 and distal 1002 ends of the length of material 1004.

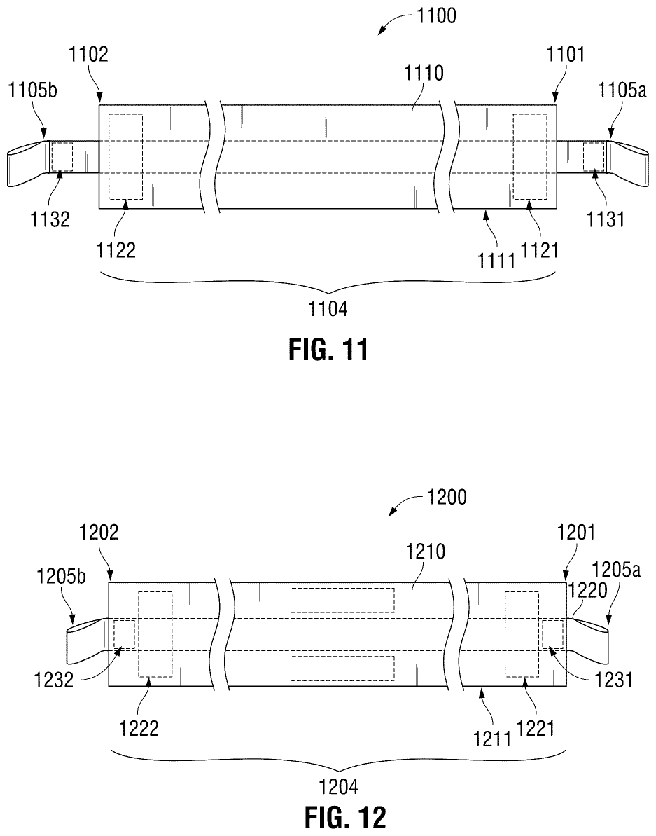

FIG. 11 depicts a topside view of an embodiment of the restroom privacy barrier 1100. Some embodiments may contain a spine 1120 of material running the length of a length of material 1104 comprising a topside 1110 and underside 1111 of the restroom privacy barrier 1100. Some embodiments may include a spine 1120 that extends through the multiple layers of material and juts out of the proximal 1101 and distal 1102 ends of the length of material 1104. Some embodiments include adhesive zones 1131 and 1132 disposed on the underside of the spine tabs 1105a and 1105b extending the proximal 1101 and distal 1102 ends of the length of material 1004. Some embodiments include adhesive zones 1121 and 1122 disposed on the underside 1111 of the length of material bottom layer at the proximal 1101 and distal 1102 ends of the length of material 1104 comprising the restroom privacy barrier 1100. Some embodiments, such as those depicted in FIG. 11 include loops or pull tabs 1105a and 1105b formed at the proximal and distal ends of said spine 1120, wherein such loops or pull tabs provide additional material for a user to grasp or leverage as they handle the barrier or during removal and disengagement of the barrier 1100 from the wall or door surface it may be adhered to.

FIG. 12 depicts an alternative topside view of an embodiment of the restroom privacy barrier 1200. Some embodiments may contain a spine 1220 of material running the length of a length of material 1204 comprising a topside 1210 and underside 1211 of the restroom privacy barrier 1200. Some embodiments may include a spine 1220 that extends through the multiple layers of material and juts out of the proximal 1201 and distal 1202 ends of the length of material 1204. Some embodiments include adhesive zones 1231 and 1232 disposed on the underside of the spine tabs 1205a and 1205b extending the proximal 1201 and distal 1202 ends of the length of material 1204. Some embodiments include adhesive zones 1221 and 1222 disposed on the underside 1211 of the length of material bottom layer at the proximal 1201 and distal 1202 ends of the length of material comprising the restroom privacy barrier 1200. As depicted, some embodiments may include adhesive zones 1223 at a medial point of the length of material. Some embodiments, such as those depicted in FIG. 12 include loops or pull tabs 1205a and 1205b formed at the proximal and distal ends of said spine 1220, wherein such loops or pull tabs provide additional material for a user to grasp or leverage as they handle the barrier or during removal and disengagement of the barrier from the wall or door surface it may be adhered to. Some embodiments include additional spine material situated within the layers of material forming the privacy barrier 1200, wherein pull tabs or loops formed at the proximal and distal ends of said spine allow for a user to pull a portion of the spine out and away from the proximal and distal ends of the length of material to expose the adhesive material 1231 and 1232 disposed on the underside of said spine 1220.

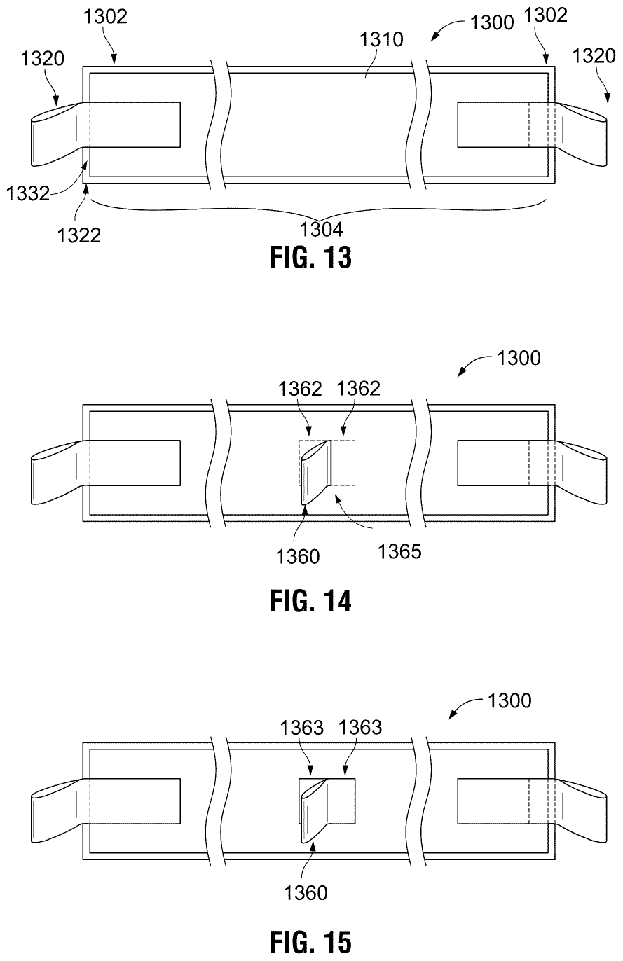

FIG. 13 depicts an alternative topside view of an embodiment of the restroom privacy barrier 1300. Some embodiments may contain one or more tabs 1320 of material extending from one or both the proximal and distal ends 1302 of a length of material 1304 comprising a topside 1310 and underside (not shown) of the restroom privacy barrier 1300. Some embodiments may include a top layer of material 1304 and a liner 1322, where the top layer of material has a topside 1310 and underside (not shown) wherein the underside further includes an adhesive coating 1332 or application of adhesive material. It should be appreciated that the adhesive coating or application of adhesive material may extend along a substantial length of the material or positioned in varying spots along the length of material, e.g. at or near the proximal and/or distal ends of the material, medial point of the material, or distributed near or along one or more exterior edges of the underside of the length of material. Some embodiments may include one or more tabs 1320 that may include or comprise a loop of material wherein the tab is formed and adhered to the top layer of material. It should be appreciated that the tab need not be formed as a loop but may instead be a single layer or multi-layer pull tab without a loop. It should be appreciated that the liner 1322 of the restroom privacy barrier 1300 may be removed and discard, as discussed herein, allowing for the top layer of material's underside to be adhered to a surface, e.g. a restroom stall wall, to cover gap(s) allowing additional privacy for the occupant of the stall or additional security or maintaining closure of the stall door in the event the lock or latch in the stall is broken or missing.

FIG. 14 depicts an alternative embodiment of the restroom privacy barrier 1300 from FIG. 13 further including an additional pull tab 1360 extending through a cavity 1365 formed on the top layer of material and secured via securing tabs 1362 of material via an adhesive to the underside of the material. It should be appreciated that the pull tab may be formed as a loop or a single layer or multi-layer of material without a loop.

FIG. 15 depicts an alternative embodiment of the restroom privacy barrier 1300 in FIG. 13 further including an additional pull tab 1360 positioned and formed on the top layer of material and secured via securing tabs 1363 of material via an adhesive to the topside of the top layer of material. It should be appreciated that the pull tab may be formed as a loop or a single layer or multi-layer of material without a loop.

It should be appreciated that the material comprising the layers of the restroom privacy barrier may be composed of biodegradable, flushable, water soluble, and/or recyclable materials, such as cloth, cotton, paper, film, polyvinyl acetate (PVA), tissue paper, toilet paper, cardboard, corn starch, rice paper, bleached tissue, virgin pulp biodegradable material, marine-degradable biomass derived plastics, water soluble plastics, organic fibers, bamboo, green plastic, soil-biodegradable plastic, biomass plastic, bioplastic, biobased, compostable plastic, hemp, polylactic acid (PLA), polyhydroxyalkanoates (PHA), bioplastic wood base, bioplastic algae base, wood pulp, cellulose, plant-based fibers, egg shell, food waste byproducts, human or animal waste byproducts, and/or kraft paper. It should be appreciated that multiple materials may be used in the composition of the restroom privacy barrier that provide different levels of water solubility and decomposition after being disposed or flushed. That is the spine may comprise a water soluble film, such as PVA, while the top layer and under layer material comprises tissue paper. It should be appreciated that various combinations of materials may be used in the composition of the restroom privacy barrier depending on costs, biodegradability, flushability, size, packaging limitations, and weight among other considerations.

It should be appreciated that the adhesive material may comprise a reusable adhesive composition to allow engagement and disengagement of the adhesive to allow for reuse of the restroom privacy barrier. Some embodiments may comprise an adhesive composition that allows for ease of use to provide enough adhesion to maintain the restroom privacy barrier in place until the user is finished with the barrier and ease of removal without leaving adhesive residue. It should also be appreciated that the adhesive material should preferable be comprised of a biodegradable and/or water soluble composition to avoid clogging plumbing after flushing the barrier in the toilet or to aid in recyclability of the barrier when disposed via a waste or recycling bin.

While preferred embodiments have been shown and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied. Further, it should be appreciated that the disclosure and teachings of the several embodiments described herein may be used interchangeably to achieve different embodiments not explicitly depicted. Accordingly, it is intended that the following claims be interpreted to embrace all such variations and modifications.

What is claimed is the following:

1. A restroom privacy barrier comprising:
a first layer of material comprising a length, a proximal end, a distal end, a top surface, and a bottom surface;
a spine, said spine comprising a length greater than the length of said first layer of material, a proximal end, a distal end, a top surface, and a bottom surface;
a plurality of adhesive zones wherein an adhesive material is disposed;
wherein said bottom surface of said spine is disposed on said top surface of said first layer of material, wherein said proximal end of said spine extends beyond the proximal end of said first layer of material forming a first tab and said distal end of said spine extends beyond the distal end of said first layer of material forming a second tab.

2. The restroom privacy barrier of claim 1 further comprising:
a second layer of material comprising a length, a proximal end, a distal end, a top surface, and a bottom surface, wherein said bottom surface of said second layer of material is disposed on said top surface of said first layer of material and said top surface of said spine, wherein said top surface of first layer of material is fixedly joined to said bottom surface of said second layer of material, wherein said spine movably extends through the fixedly joined first layer of material and second layer of material.

3. The restroom privacy barrier of claim 1, wherein the plurality of adhesive zones are disposed on the bottom surfaces of said proximal and distal ends of said spine.

4. The restroom privacy barrier of claim 2, wherein the plurality of adhesive zones are disposed on the bottom surfaces of said proximal and distal ends of said spine.

5. The restroom privacy barrier of claim 1, wherein the plurality of adhesive zones are disposed on the bottom surface of said first layer of material at said proximal and distal ends of said first layer of material.

6. The restroom privacy barrier of claim 2 further comprising: wherein the plurality of adhesive zones are disposed on the bottom surface of said first layer of material at said proximal and distal ends of said first layer of material.

7. The restroom privacy barrier of claim 3 further comprising: wherein the plurality of adhesive zones are disposed on the bottom surface of said first layer of material at said proximal and distal ends of said first layer of material.

8. The restroom privacy barrier of claim 4 further comprising: wherein the plurality of adhesive zones are disposed on the bottom surface of said first layer of material at said proximal and distal ends of said first layer of material.

9. The restroom privacy barrier of claim 1 further comprising:
a plurality of wings extended at a medial point of said length of material of said first layer of material or said second layer of material or both, wherein said plurality of wings each comprise a bottom surface and top surface, whereupon disposed on each of said bottom surface of said plurality of wings is a wing adhesive zone.

10. The restroom privacy barrier of claim 2 further comprising:
a plurality of wings extended at a medial point of said length of material of said first layer of material or said second layer of material or both, wherein said plurality of wings each comprise a bottom surface and top surface, whereupon disposed on each of said bottom surface of said plurality of wings is a wing adhesive zone.

11. The restroom privacy barrier of claim 7 further comprising:
a plurality of wings extended at a medial point of said length of material of said first layer of material or said second layer of material or both, wherein said plurality of wings each comprise a bottom surface and top surface, whereupon disposed on each of said bottom surface of said plurality of wings is a wing adhesive zone.

12. The restroom privacy barrier of claim 8 further comprising:
a plurality of wings extended at a medial point of said length of material of said first layer of material or said second layer of material or both, wherein said plurality of wings each comprise a bottom surface and top surface, whereupon disposed on each of said bottom surface of said plurality of wings is a wing adhesive zone.

13. The restroom privacy barrier of claim 2 wherein said second layer of material further comprises a medial point, wherein a through hole is formed in said second layer of material, wherein a loop is formed of a length of material forming said spine, wherein said loop extends through the through hole formed at the medial point of said second layer of material.

14. The restroom privacy barrier of claim 4 wherein said second layer of material further comprises a medial point, wherein a through hole is formed in said second layer of material, wherein a loop is formed of a length of material forming said spine, wherein said loop extends through the through hole formed at the medial point of said second layer of material.

15. The restroom privacy barrier of claim 6 wherein said second layer of material further comprises a medial point, wherein a through hole is formed in said second layer of material, wherein a loop is formed of a length of material forming said spine, wherein said loop extends through the through hole formed at the medial point of said second layer of material.

16. The restroom privacy barrier of claim 8 wherein said second layer of material further comprises a medial point, wherein a through hole is formed in said second layer of material, wherein a loop is formed of a length of material forming said spine, wherein said loop extends through the through hole formed at the medial point of said second layer of material.

17. The restroom privacy barrier of claim 10 wherein said second layer of material further comprises a medial point, wherein a through hole is formed in said second layer of material, wherein a loop is formed of a length of material forming said spine, wherein said loop extends through the through hole formed at the medial point of said second layer of material.

18. The restroom privacy barrier of claim 12 wherein said second layer of material further comprises a medial point, wherein a through hole is formed in said second layer of material, wherein a loop is formed of a length of material forming said spine, wherein said loop extends through the through hole formed at the medial point of said second layer of material.

19. The restroom privacy barrier of claim 1 wherein said first layer material, said second layer of material, and said spine comprise a biodegradable, flushable, composition.

20. The restroom privacy barrier of claim 2 wherein said first layer material, said second layer of material, and said spine comprise a biodegradable, flushable, composition.
